(19) United States
(12) Patent Application Publication
(10) Pub. No.: US 2004/0156054 A1
(43) Pub. Date: Aug. 12, 2004

(54) Method for measuring an object by means of a co-ordinate measuring device with image processing sensor

(76) Inventor: Ralf Christoph, Giessen (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/482,401

(22) PCT Filed: Jul. 5, 2002
(86) PCT No.: PCT/EP02/07468

(30) Foreign Application Priority Data
Jul. 16, 2001 (DE) 101 33 839.2

(51) Int. Cl. G01B 11/24

(52) U.S. Cl. 356/601

(57) ABSTRACT

According to the invention, objects can be measured with high precision and flexibility by means of a co-ordinate measuring device, using the following method steps: coarse alignment of the image processing sensor onto the position of the object for measuring, whereby on aligning the image processing sensor, the above is displaced with an acceleration of a₁>0 mm/s², and the braking of the image processing sensor and measurement of the position with a moving image processing sensor occurs with an acceleration of a₂ 0 mm/s²≦a₂<a₁.

The invention relates to a method for measuring an object with a coordinates measuring device with image processing and sensor.

Optical or opto-electronic measuring methods are used in order to make possible a precise and highly exact geometrical recording of different work pieces. The main advantage of this is its high flexibility and processing speed. Moreover the measurement or examination with CCD cameras as image processing sensors represents a technology which is similar to human perception and therefore is basically suited for industrial job specifications. Image recording, image conditioning and transmission as well as image processing comprise steps of image processing.

The measurement or an object or measuring point or measuring range takes place with a stationary image processing sensor or CCD camera. In this way the measuring speed experiences loss.

The present invention is based on the problem of refining the method mentioned at the beginning such that measurement can take place at a high measuring speed with high precision and flexibility.

The problem is solved by a method for measuring an object with a coordinates measuring device with image processing sensor which is characterized by the operations:

Crude orientation of the image processing sensor toward the position of the object to be measured, whereby the image processing sensor is moved at an acceleration a₁>0 mm/s² during or prior to the crude orientation, and

Braking the image processing sensor and measuring the position when the image processing sensor is moved at an acceleration a, with 0 mm/s²≦a₂<a₁.

Moreover, in particular the object is acted upon during the measurement with a light flash and/or a CCD camera with shutter is used as image processing sensor. A correlation between movement of the sensor and the respective image to be recorded takes place through measures related to this, whereby an apparent stoppage of the image processing sensor is realized by the light flash or shutter with the consequence such that the measurements are conducted as if the image processing sensor were standing still during the measurement.

Consequently, in accordance with the invention, the image processor is moved to the position to be measured only crudely by the coordinates measuring device and then to measure when the image processing sensor (which can be moved at a speed of v₁ of, for example, 50-200 mm/s) is moved further, but basically not accelerated. Moreover the image memory requisite for measuring can be recognized in the image-processing sensor by reaching a target area. Thus the braking can be introduced by optical recording of the region of the object containing the position using the image-processing sensor.

In particular, the invention provides a motion of the image-processing sensor such that the object or measuring regions or measuring points are measured at a speed v₁. Subsequently, the image processing sensor is strongly accelerated, for example to a value of ca. 5000-15,000 mm/s in order then to be crudely oriented to the measuring region or the measuring point at an acceleration of 0 mm/s² at a speed v₂ between 400 and 600 mm/s. Then a braking of the image processing sensor to speed v, in the region between 50 mm/s and 150 mm/s takes place in order to measure. During this time, the object or the region to be measured can be acted upon with light flashes, or the shutter of the image-processing sensor can be opened and closed at the desired frequency. After the measurement has taken place, the image-processing sensor is accelerated in the previously described way in order to be oriented toward a new measuring point or region.

Further details, advantages and features of the invention become apparent not only from the claims, the features to be inferred from them alone or in combination, but also on the basis of the following description of the drawings, wherein:

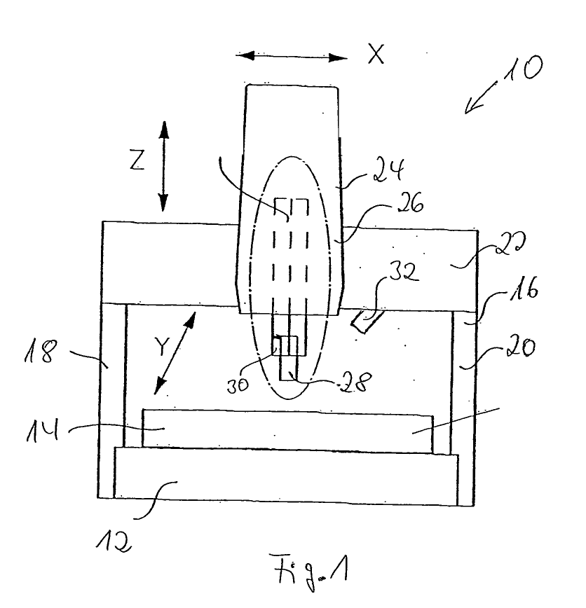

FIG. 1 Illustrates a basic representation of a coordinates measuring device,

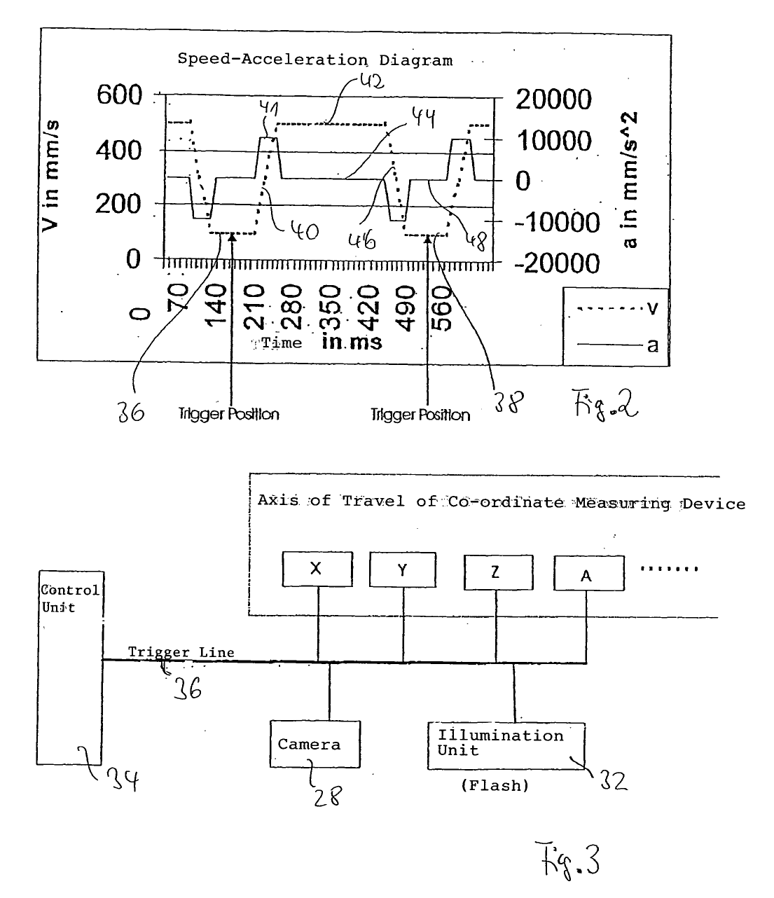

FIG. 2 Illustrates a sequence of motion of an image processing sensor in the speed-acceleration diagram and

FIG. 3 Illustrates a block diagram.

An optically operating coordinates measuring device 10 which has a supporting frame 12 in a known manner, on which a measuring table 14 is arranged is very basically represented in FIG. 1. An object (not represented) which is to be measured is then placed upon this. A portal 16 is adjustable in the Y direction along the supporting frame 12. Columns or stands 18, 20 are supported sliding on the supporting frame 12 for this purpose. A traverse 22 proceeds from the columns 18, 20, along which (thus in the X direction), a carriage 24 can be adjusted, which for its part has a spindle sleeve or column 26 which can be adjusted in the Z direction. An image-processing sensor proceeds from the spindle sleeve or column 26.

Furthermore a gap sensor 30 is incorporated into the spindle sleeve to determine the height profile during measurement of the object. Finally a lighting unit 32, such as a stroboscope, proceeds from the traverse 22, if need be also from the spindle sleeve 26, in order to subject the object with light flashes during measurement.

It is provided in accordance with the invention that the image processing sensor 28 is crudely oriented toward a position to be measured to measure an object using the image processing sensor 28, such as a CCD camera, in order then to measure the object during its motion. A control unit 34 is provided for this which first actuates and adjusts the coordinates measuring device in relation to its axes X, Y, Z as well as axis of rotation A through a control or trigger line 36, and second actuates and adjusts the sensor 28 designated as a camera in FIG. 3 as well as a lighting unit 32, where it can be a matter of a stroboscope. A shutter placed in front of the camera 28 is also controlled to the extent that the duration of the recording of the position of the object is determined by this.

A speed-acceleration diagram for the motion of the sensor 28 is reproduced in FIG. 2. Here the speed is basically reproduced by the dotted line and the acceleration of sensor 28 by the solid line. The regions 36, 38 characterized with “trigger position” represent those in which a measurement takes place. Moreover, in accordance with the embodiment, sensor 28 moves at a speed of, for example, 100 mm/sec. During measurement, thus during time 36, 38, the sensor 18 is not accelerated. After measurement, an acceleration (regions 40 or 41) takes place in order then move the sensor 28 during the crude positioning of the sensor 28 on the measuring region when acceleration is lacking (straight line 44) at a speed of 500 mm/s (region 42) for example. After the crude orientation takes place (end of time span 26), the sensor 28 is negatively accelerated, thus braked (flank 44), in order then to be moved at a speed of, for example, 100 mm/s during measuring, when acceleration is absent (straight line 48), whereby the shutter or the stroboscope become active.

In order to focus the image-processing sensor 28, such as the CCD camera, sharply on the measuring region, the distance to the object or its height profile are measured by the gap sensor 30. In this way, it is assured that measurement errors due to blurred imaging of the measured region are ruled out.

In order to improve the exactitude of measurement, the beginning and end of the respective image recording, thus the time difference Δt, are converted into a length of travel. For example, if the image recording begins at a time t₁ that corresponds to a distance Z₂, then the measurement is allocated the distance (z₁+z₂):2. The same applies for the other coordinates.

1. Method for measuring an object with a coordinates measuring device with image processing sensor characterized by the operations:
crude orientation of the image processing sensor toward the position of the object to be measured, whereby the image processing sensor is moved at an acceleration a₁>0 mm/s² during or prior to the crude orientation, and
braking the image processing sensor and measuring the position when the image processing sensor is moved at an acceleration a, with 0 mm/s²≦a₂<A₁.

2. Method according to claim 1, wherein the image processing sensor is moved in the X and/or Y and/or Z axis direction of the coordinates measuring device and/or about at least one specified axis of rotation A during measuring.

3. Method according to claim 1 or 2, wherein the object is subjected to a light flash during measuring.

4. Method according to at least one of the preceding claims, wherein a CCD camera with shutter is used as the image processing sensor.

5. Method according to at least one of the preceding claims, wherein the braking is introduced by optical recording of the region of the object containing the position.

6. Method according to at least one of the preceding claims, wherein a gap sensor is used to adjust the operating distance of the image-processing sensor to the position or a region containing the position.

7. Method according to at least one of the preceding claims, wherein the height profile of the object is measured during the motion of the image processing sensor using a gap sensor integral with the image processing sensor or allocated to this for sharp focusing of the image processing sensor.

8. Method according to at least one of the preceding claims, wherein the image-processing sensor is moved with the acceleration a₂=0 mm/s² while the position is being measured.

9. Method according to at least one of the preceding claims, wherein the image-processing sensor is moved at a speed v₁ with 20 mm/s≦v₁≦200 mm/s, especially 50 mm/s≦v₁≦150 mm/s during measurement of the position.

10. Method according to at least one of the preceding claims, wherein the image-processing sensor is accelerated after a measurement, then moved on at almost constant speed v₂ for crude positioning of the image-processing sensor, is braked directly prior to measurement and is moved at speed v₁ during measurement.

11. Method according to at least one of the preceding claims, wherein the image-processing sensor is moved at a speed v₂ with preferably 100 mm/s≦v₂≦1000 mm/s during crude positioning.
